(19) United States
(12) Patent Application Publication
(10) Pub. No.: US 2019/0291402 A1
(43) Pub. Date: Sep. 26, 2019

(54) COMPOSITE MATERIALS AND MACHINES AND METHODS TO PRODUCE SAME

(71) Applicant: SABIC Global Technologies B.V., Bergen op Zoom (NL)

(72) Inventors: Rakshit AMBA, East Greenbush, NY (US); Lakshmikant Suryakant POWALE, Delmar, NY (US)

(21) Appl. No.: 15/758,842

(22) PCT Filed: Sep. 8, 2016
(86) PCT No.: PCT/US2016/050615

§ 371 Date: Mar. 9, 2018

(30) Foreign Application Priority Data
Sep. 10, 2015 (IN) 2830/DEL/2015

(51) Int. Cl. B32B 37/20; B32B 17/10; B32B 17/06; B32B 27/36; B32B 37/00; B32B 37/15

(52) U.S. Cl. CPC B32B 37/203; B32B 17/10862; B32B 17/064; B32B 27/365; B32B 37/0053; B33Y 10/00; B32B 2307/584; B32B 2307/714; B32B 2315/08; B32B 2369/00; B32B 37/15

(57) ABSTRACT

In certain applications it can be desirable to combine a first material having a first set of properties, for example mechanical and physical properties, with a second material having a second set of properties that are different than the first set properties. The combination of the first material and the second material can result in a third material having a third set of properties that include at least some of the first set of properties and at least some of the second set of properties. Composite materials, machines configured to produce composite materials, and methods of manufacturing composite materials are described in the present disclosure.

### RELATED APPLICATION

The present application claims priority to and the benefit of Indian Provisional application no. 2830/DEL/2015, “Composite Materials and Machines and Methods to Produce Same” (filed Sep. 10, 2015), the entirety of which is incorporated herein by reference for any and all purposes.

### TECHNICAL FIELD

This document pertains generally, but not by way of limitation, to composite materials. More specifically, the present application is related to glass materials, plastic materials such as thermoplastics and polycarbonates, additive manufacturing materials, and any combination thereof in addition to machines and methods for the production of the composite materials.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the drawings that form a part of this document: Copyright 2015, SABIC Innovative Plastics. All Rights Reserved.

### BACKGROUND

Glass materials and plastic materials are each used individually in a variety of applications that make use of the mechanical and physical properties of the respective material. Sonic glass materials are known to include better scratch resistance, better chemical resistance, and better barrier properties than some plastic materials. Some plastic materials are known to include better formability, faster manufacturing speed, and improved bonding characteristics than some glass materials. A composite material that includes both a glass material and a plastic material can reap the benefits of the strengths of each of the glass material and the plastic material while minimizing the weaknesses of the glass material and the plastic material.

Garner (WO 2014/133923) discloses a flexible glass substrate and a polymer material that can each be wound into respective coiled spools and brought together to form a glass-polymer laminate. Tummala (2013/173742) discloses adhesives for use with a three-dimensional printer, the adhesives configured to bond extruded material to a print pad such that the printed material can be easily separated from the print pad after completion of the print process. Short comings of the prior art are addressed by the present disclosure.

### OVERVIEW

The present inventors have recognized, among other things, that glass materials are difficult to integrate with plastic components, especially in a high-speed manufacturing operation. The addition of a polymer material to the glass material, for example through a lamination process may improve the integration of the combined glass/polymer material with plastic components. Hand lamination of glass/polymer materials often introduces defects into the combined material, such as bubbles and cracks. In addition, hand lamination of glass/polymer materials often results in the production of high scrap rates and slow manufacturing speed.

The present subject matter can help provide a solution to this problem, by providing composite materials and machines and methods for producing the same that result in a combined material that is easy to integrate with plastic components, and that is producible at high manufacturing speeds with a low occurrence of defects.

This overview is intended to provide an overview of subject matter of the present patent application. It is not intended to provide an exclusive or exhaustive explanation of the present devices or techniques. The detailed description is included to provide further information about the present patent application.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various examples discussed in the present document. In the drawings:

FIG. 1 is a side view of a machine according to one aspect of the disclosure;

FIG. 2 is a schematic side elevation view of the machine illustrated in FIG. 1;

FIG. 3 is a side view of a machine according to another aspect of the disclosure;

FIG. 4 is an isometric view of a first material and a second material according to one aspect of the disclosure;

FIG. 5 is a cross-sectional view of the second material illustrated in FIG. 4, along line 5-5;

FIG. 6 is a side view of a machine according to another aspect of the disclosure;

FIG. 7 is a side view of a composite material according to one aspect of the disclosure;

FIG. 8 is a top plan view of a composite material according to a composite material according to another aspect of the disclosure;

FIG. 9 is a cross-sectional view of the composite material illustrated in FIG. 8, along line 9-9;

FIG. 10 is a top plan view of a composite material according to a composite material according to another aspect of the disclosure;

FIG. 11 is a cross-sectional view of the composite material illustrated in FIG. 10, along line 11-11;

FIG. 12 is a side view of a composite material according to another aspect of the disclosure;

FIG. 13 is a side view of a composite material according to another aspect of the disclosure;

FIG. 14 is an isometric view of a composite material according to one aspect of the disclosure;

FIG. 15 is a cross-sectional view of the composite material illustrated in FIG. 14, according to one aspect of the disclosure, along the line 14-14.

### DETAILED DESCRIPTION

Aspects of the disclosure will now be described in detail with reference to the drawings. Certain terminology is used in the following description for convenience only and is not limiting. The term “plurality”, as used herein, means more than one. The terms “a portion” and “at least a portion” of a structure each include the entirety of the structure. Certain features of the disclosure that are described herein in the context of separate examples can also be provided in combination in a single example. Conversely, various features of the disclosure that are described in the context of a single example can also be provided separately or in any subcombination.

In certain applications it can be desirable to combine a first material having a first set of properties, for example mechanical and physical properties, with a second material having a second set of properties that are different than the first set properties. The combination of the first material and the second material can result in a third material having a third set of properties that include at least some of the first set of properties and at least some of the second set of properties.

In one aspect of the disclosure the first material can include, but is not limited to, glass or glass-like materials. Reference to a glass (or glass-like) material, and a glass (or glass-like) layer can include, but is not limited to chemically strengthened glass, soda lime glass, flexible glass, and tempered glass. In one aspect of the disclosure the second material can include, but is not limited to, plastic materials, for example thermoplastics such as LEXAN™ resin and ULTEM™ resin. The second set of properties can include, but is not limited to, formability, rapid manufacturability, and ability to be secured to other materials. In one aspect of the disclosure the third material can include, but is not limited to, at least one layer of the first material, for example a glass or glass-like material, and at least one layer of the second material, for example a plastic material. The third set of properties can include scratch resistance, chemical resistance, and the ability to be secured to other materials.

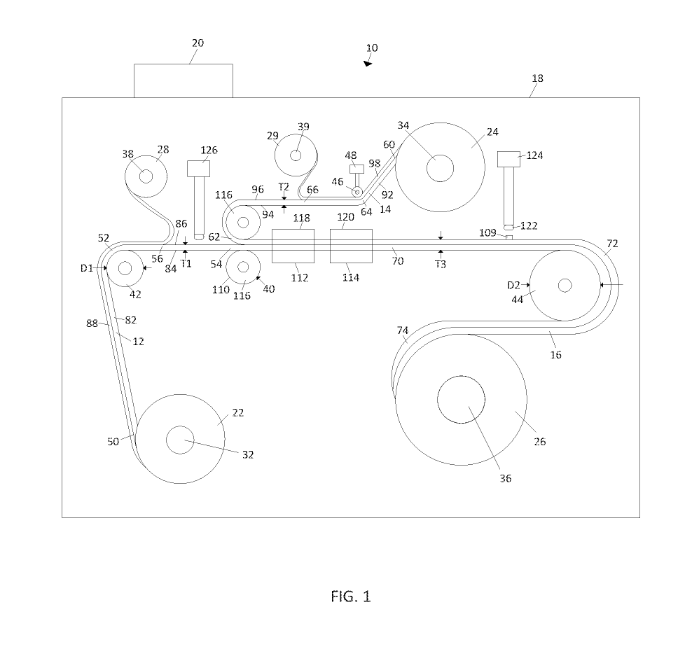

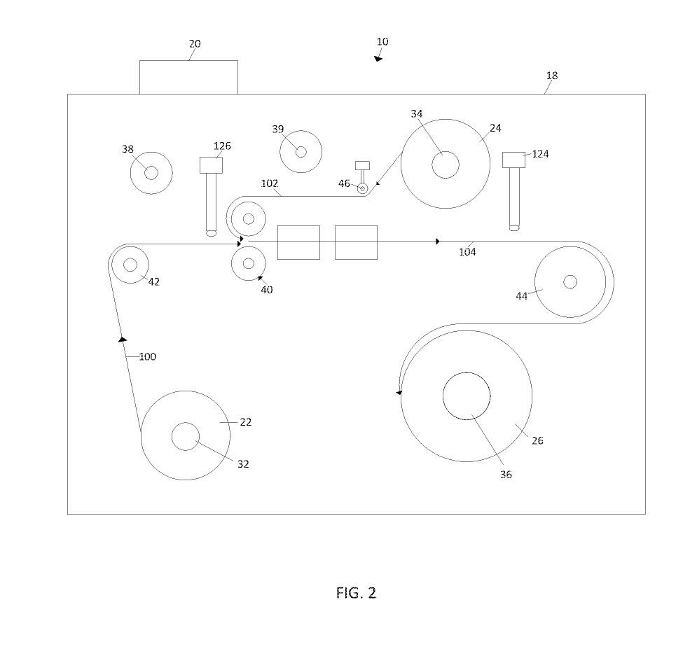

Referring to FIGS. 1 and 2, a machine 10 in one aspect of the disclosure is configured to secure a first material 12 to a second material 14 thereby forming a third material 16. The machine 10 can include a frame 18 that at least partially encloses the first material 12, the second material 14, the third material 16, or any combination thereof during operation of the machine 10. In one example the frame 18 is configured to enclose an entirety of the first material 12, the second material 14, the third material 16, and all other components of the machine 10 during operation of the machine 10. The machine 10 can include a filtration system 20 configured to remove impurities, for example dust, from an area enclosed by the frame 18.

As shown in the illustrated example, the machine 10 can be configured to receive a first roll 22 of the first material 12 and a second roll 24 of the second material 14. The machine 10 can be further configured to secure the first material 12 to the second material 14 to form a third roll 26 of the third material 16.

The machine 10 can include a first mount 32, a second mount 34, and a third mount 36 that are each rotatably coupled to the frame 18. The first mount 32, the second mount 34, and the third mount 36 can each be configured to receive one of the first roll 22, the second roll 24, and the third roll 26. As shown in the illustrated example, the machine 10 can be configured such that the first mount 32 is configured to receive the first roll 22, the second mount 34 is configured to receive the second roll 24, and the third mount 36 is configured to receive the third roll 26.

The machine 10 includes an apparatus configured to secure the first material 12 to the second material 14, the apparatus referred to herein as a laminator 40. The laminator 40 is configured to receive both the first material 12 and the second material 14 as separate inputs and output the third material 16, that includes the first material 12 secured to the second material 14.

The machine 10, in an aspect of the disclosure can include a plurality of idlers. The plurality of idlers, in one aspect of the disclosure, can include a first idler 42, a second idler 44, a third idler 46, or any combination thereof. The first idler 42 defines a first outer diameter D1, and the second idler 44 defines a second outer diameter D2. The machine 10 defines a first path 100 from the first mount 32 to the laminator 40, a second path 102 from the second mount 34 to the laminator 40, and a third path 104 from the laminator 40 to the third mount 36. In one aspect of the disclosure the first path 100 is partially defined by the first idler 42 such that the first idler 42 is positioned between the first mount 32 and the laminator 40, with respect to the first path 100. In one aspect of the disclosure the third path 104 is partially defined by the second idler 44 such that the second idler 44 is positioned between the laminator 40 and the third mount 36, with respect to the third path 104.

As shown in the illustrated example, the machine 10 can be configured such that the first path 100 extends from the first mount 32 to the first idler 42, around at least a portion of the first idler 42, and to the laminator 40. The machine 10 can further be configured such that the second path 102 extends from the second mount 34 to the laminator 40. The machine 10 can further be configured such that the third path 104 extends from the laminator 40, around at least a portion of the second idler 44, and to the third mount 36.

In one aspect of the disclosure, the machine 10 defines an operating configuration in which: the first roll 22 of the first material 12 is coupled to the first mount 32, a first portion 50 of the first material 12 exits the first mount 32 and travels along the first path 100 to the first idler 42, a second portion 52 of the first material 12 contacts the first idler 42, a third portion 54 of the first material 12 enters the laminator 40, and the second portion 52 is between the first portion 50 and the third portion 54 with respect to the first path 100.

In one aspect of the disclosure, when the machine 10 is in the operating configuration: the second roll 24 of the second material 14 is coupled to the second mount 34, a first portion 60 of the second material 14 exits the second mount 34 and travels along the second path 102 toward the laminator 40, and a second portion 62 of the second material 14 enters the laminator 40. In one aspect of the disclosure, the third idler 46 of the machine is rotatably coupled to the frame 18 such that in the operating configuration a third portion 64 of the second material contacts the third idler 46 such that the third portion 64 is between the first portion 60 and the second portion 62 with respect to the second path 102.

The machine 10 can be configured such that in the operating configuration the third idler 46 applies a force to the third portion 64 of the second material 14. The machine 10 can be configured such that the force applied by the third idler 46 improves the combination of the first material 12 and the second material 14, for example by preventing the formation of bubbles between the first material 12 and the second material 14 when combined to form the third material 16. The machine 10 can include a tension transducer 48 configured to measure the force being applied to the third portion 64 by the third idler 46.

In one aspect of the disclosure, when the machine 10 is in the operating configuration: the third roll 26 of the third material 16 is coupled to the third mount 36, a first portion 70 of the third material 16 exits the laminator 40 and travels along the third path 104 to the second idler 44, a second portion 72 of the third material 16 contacts the second idler 44, a third portion 74 of the third material 16 enters the third roll 26, and the second portion 72 is between the first portion 70 and the third portion 74 with respect to the third path 104.

In one aspect of the disclosure, the first material 12 includes a glass layer 82 that defines a thickness T1. The thickness T1 in one example can be between about 50 microns and about 200 microns. The thickness T1 in another example can be less than about 50 microns or greater than about 200 microns. As shown in the illustrated example, the thickness T1 is measured at a location and along a direction perpendicular to the direction of the first path 100 at the location. The glass layer 82 includes a first surface 84 and a second surface 86. The first surface 84 is opposite the second surface 86 and the thickness T1 is measured from the first surface 84 to the second surface 86.

The first material 12 can also include a protective layer 88 that is removably attached to the glass layer 82. The first material 12 can be configured such that the protective layer 88 is positioned between adjacent portions of the glass layer 82 when the first material 12 is on the first roll 22. In other words, the first material 12 can be configured such that the protective layer 88 is positioned to prevent any two portions of the glass layer 82 from directly contacting each other.

In one aspect of the disclosure, the machine 10 is configured to separate the protective layer 88 from the glass layer 82 and thus remove the protective layer 88 from the first material 12. As shown in the illustrated example, the machine 10 can include a fourth mount 38 rotatably coupled to the frame 18 such that the fourth mount 38 is configured to receive the removed protective layer 88 and form a fourth roll 28 of the protective layer 88 on the fourth mount 38.

The machine 10 can be configured such that when the machine 10 is in the operating configuration the protective layer 88 is separated from the glass layer 82 at a fourth portion 56 of the first material 12. As shown in the illustrated example, the fourth portion 56 of the first material 12 can be positioned between the second portion 52 of the first material 12 and the third portion 54 of the first material 12 with respect to the first path 100.

In one aspect of the disclosure, the second material 14 includes a thermoplastic layer, for example a polycarbonate layer 92 that defines a thickness T2. The thickness T2 in one example can be between about 15 microns and about 100 microns. The thickness T2 in another example can be less than about 15 microns or greater than about 100 microns. As shown in the illustrated example, the thickness T2 is measured at a location and along a direction perpendicular to the direction of the second path 102 at the location. The polycarbonate layer 92 includes a first surface 94 and a second surface 96. The first surface 94 is opposite the second surface 96 and the thickness T2 is measured from the first surface 94 to the second surface 96.

The second material 14 can also include a protective layer 98 that is removably attached to the polycarbonate layer 92. According to one aspect of the disclosure, the second material 14 can be configured such that the protective layer 98 is positioned between adjacent portions of the polycarbonate layer 92 when the second material 14 is on the second roll 24. In other words, the second material 14 can be configured such that the protective layer 98 is positioned to prevent any two portions of the polycarbonate layer 92 from directly contacting each other.

In one aspect of the disclosure, the machine 10 is configured to separate the protective layer 98 from the polycarbonate layer 92 and thus remove the protective layer 98 from the second material 14. As shown in the illustrated example, the machine 10 can include a fifth mount 39 rotatably coupled to the frame 18 such that the fifth mount 39 is configured to receive the removed protective layer 98 and form a fifth roll 29 of the protective layer 98 on the fifth mount 39.

The machine 10 can be configured such that when the machine 10 is in the operating configuration the protective layer 98 is separated from the polycarbonate layer 92 at a fourth portion 66 of the second material 14. As shown in the illustrated example, the fourth portion 56 of the first material 12 can be positioned between the first portion 60 of the second material 14 and the second portion 62 of the second material 14, for example between the third portion 64 of the second material 14 and the second portion 62 of the second material 14 with respect to the second path 102.

The laminator 40 is configured to secure the first material 12 to the second material 14. In accordance with one aspect of the disclosure the laminator 40 can include a pressure source 110, a light source 112, a heat source 114, or any combination thereof. For example, the laminator 40 can include a pair of nip rollers 116, an ultraviolet light source 118, a heating element 120, or any combination thereof. As shown in the illustrated example, the laminator 40 can include separate ones of the pressure source 110, the light source 112, the heat source 114, or any combination thereof. In another aspect of the disclosure, the laminator 40 can include a single component that includes any combination of the pressure source 110, the light source 112, and the heat source 114. For example, the pair of nip rollers 116 can be heated such that the pair of nip rollers 116 provides the pressure source 110 and the heat source 114.

The laminator 40 can be configured to activate one or more adhesives to secure the first material 12 to the second material 14 and form the third material 16. For example, the one or more adhesives can include a pressure activated adhesive, a light activated adhesive, a heat activated adhesive, or any combination thereof. The adhesive can be an optically clear adhesive. As shown in the illustrated example, when the machine 10 is in the operating configuration, the glass layer 82 of the first material 12 and the polycarbonate layer 92 of the second material 14 each enter the laminator 40, and a third material 16 exits the laminator 40. The third material 16 includes the glass layer 82 and the polycarbonate layer 92 secured to each other, for example by the adhesive.

In one aspect of the disclosure, the machine 10 can include an additive manufacturing printer 122 that is configured to secure a fourth material 109 onto the third material 16. The additive manufacturing printer 122 can be mounted to a movable arm 124, for example a robotic arm, such that the machine 10 is configured to secure a desired shape of the fourth material 109 to the third material 16. As shown in the illustrated example, the machine 10 is configured such that the additive manufacturing printer 122 is configured to secure the fourth material 109 to the polycarbonate layer 92 of the third material 16. It should be understood that depending on the size and shape of the fourth material 109 that is applied to the third material 16, the combined third material 16 and the fourth material 109 cannot be formed into a roll, and can instead be cut into separate pieces.

In one aspect of the disclosure, the machine 10 can include a movable arm 126 configured to apply a material to the first material 12 before the first material 12 enters the laminator 40. For example, the movable arm 126 can be configured to apply an adhesive to the first material 12, the adhesive configured to be activated by the laminator 40, thereby securing the first material 12 to the second material 14 and forming the third material 16.

Alignment of the first material 12 and the second material 14 with respect to each other as the first material 12 and the second material 14 enter the laminator 40 can affect the quality of the adhesion of the first material 12 to the second material 14. Thus the machine 10 can include the first idler 42 configured to properly align the first path 100 with respect to the laminator 40. For example, as shown in the illustrated example, the first idler 42 is configured such that the first material 12 approaches the laminator 40 along a straight line such that the first material 12 does not bend as the first material 12 enters the laminator 40.

The first set of properties of the first material 12 can include a first minimum bending radius, such that if the first material 12 is bent so as to define a radius of curvature smaller than the first minimum bending radius, the first material 12 would mechanically fail, for example crack or break. Thus in one aspect of the disclosure, the first idler 42 can be configured such that the first diameter D1 is large enough such that as the first material 12 contacts and passes over at least a portion of the first idler 42, the first material 12 does not bend so as to define a radius of curvature smaller than the first minimum bending radius.

According to one aspect of the disclosure, the first idler 42, the second idler 44, or both can include rolled aluminum. The rolled aluminum can be anodized. As shown in the illustrated embodiment, the first idler 42 and the second idler 44 are circular such that they define a cylindrical shape. Alternatively, the first idler 42, the second idler 44, or both can be arc, or pie, shaped thereby forming a partial circular shape. The arc shaped idler can include an air surface, a flow of air out of the arc idler toward the adjacent material to keep the adjacent material floating above the arc shaped idler. Typical steel rollers may decrease efficiencies due to their increased weight and additional power needed to rotate them.

The first idler 42 can further be configured such that the first diameter D1 is as small as possible, to save on the amount of space required for the machine 10, the amount of power required to operate the machine 10, and the processing time required for the machine 10 to form the third material 16. Thus, in one aspect of the disclosure, the first diameter D1 of the first idler 42 can be greater than or equal to about six inches, less than or equal to about sixteen inches, or between about six inches and about sixteen inches.

Similarly, the second set of properties of the second material 14 can include a second minimum bending radius, and the third set of properties of the third material 16 can include a third minimum bending radius. Thus in one aspect of the disclosure, the second idler 44 can be configured such that the second diameter D2 is large enough such that as the third material 16 contacts and passes over at least a portion of the second idler 44, the third material 16 does not bend so as to define a radius of curvature smaller than the third minimum bending radius.

The second idler 44 can further be configured such that the second diameter D2 is as small as possible, to save on the amount of space required for the machine 10, the amount of power required to operate the machine 10, and the processing time required for the machine 10 to form the third material 16. Thus, in one aspect of the disclosure, the second diameter D2 of the second idler 44 can be greater than or equal to about fourteen inches, less than or equal to about twenty-four inches, or between about sixteen inches and about twenty-four inches.

The second idler 44 can be configured to receive multiple cores having various outer diameters so as to enable the second idler 44 to receive various third materials 16 having various minimum bending radii.

Because the third material 16 includes a layer, for example the glass layer 82, from the first material 12 in addition to a layer, for example the polycarbonate layer 92, from the second material 14, the third minimum bending radius of the third material 16 can be larger than the first minimum bending radius. Accordingly, the machine 10 can be configured such that the first diameter D1 of the first idler 42 is smaller than the second diameter D2 of the second idler 44.

In one aspect of the disclosure, the first material 12 can define a range of values for the first thickness T1. For example, the first thickness T1 can be between about 50 microns and about 200 microns. The machine 10 can be configured such that the first diameter D1 of the first idler 42 is sized so as to operate with all of the values within the range of values for the first thickness T1, without the need for swapping out the first idler 42 for an idler with a diameter different than the first diameter D1. Thus the machine 10 can be configured to include the first idler 42 with the first diameter D1 being equal to about sixteen inches, such that the first material 12 can include the glass layer 82 with the first thickness T1 being between about 50 microns and about 200 microns.

Similarly, the third material 16 can define a range of values for a third thickness T3 of the third material 16. For example, the third thickness T1 can be between about 60 microns and about 300 microns. The machine 10 can be configured such that the second diameter D2 of the second idler 44 is sized so as to operate with all of the values within the range of values for the third thickness T3, without the need for swapping out the second idler 44 for an idler with a diameter different than the second diameter D2. Thus the machine 10 can be configured to include the second idler 44 with the second diameter D2 being equal to about twenty-four inches, such that the third material 16 can include the glass layer 82 secured to the polycarbonate layer 92 with the third thickness T3 being between about 60 microns and about 300 microns.

A method of manufacturing a composite material, for example the third material 16, can include the following steps: unrolling a portion of the first material 12 from the first roll 22 of the first material 12, the first roll 22 being coupled to the first mount 32 of the machine 10; contacting the portion of the first material 12 with at least a portion of the first idler 42 of the machine 10, the first diameter D1 of the first idler 42 being at least about six inches; unrolling a portion of the second material 14 from the second roll 24 of the second material 14, the second roll 24 being coupled to the second mount 34 of the machine 10; moving the portion of the first material 12 and the portion of the second material 14 through the laminator 40 concurrently thereby adhering the portion of the first material 12 to the portion of the second material 14 to form the third material 16; contacting a portion of the third material 16 with at least a portion of the second idler 44 of the machine 10, the second diameter D2 of the second idler 44 being at least about fourteen inches; and rolling the portion of the third material 16 onto the third roll 26 of the third material 16, the third roll 26 being coupled to the third mount 36 of the machine 10.

The method can further include the steps of: before the moving step, the step of separating a protective layer of the first material from a glass layer of the first material; before the moving step, the step of separating a protective layer of the second material from a polycarbonate layer of the second material; or both. In one aspect of the disclosure, the moving step further comprises the step of activating an adhesive thereby adhering the first material to the second material to form the third material. In one aspect of the disclosure, the activating step includes at least one of the steps of: applying light to the adhesive; applying heat to the adhesive; and applying pressure to the adhesive.

Another method of manufacturing a composite material includes the steps of: unrolling a portion of the first material 12 from the first roll 22 of the first material 12, the first roll 22 being coupled to the first mount 32 of the machine 10; contacting the portion of the first material 12 with at least a portion of the first idler 42 of the machine 10; unrolling a portion of the second material 14 from the second roll 24 of the second material 14, the second roll 24 being coupled to the second mount 34 of the machine 10; moving the portion of the first material 12 and the portion of the second material 14 through the laminator 40 concurrently thereby adhering the portion of the first material 12 to the portion of the second material 14 to form the third material 16, the third material 16 including a first surface 106, defined by a layer of the first material 12, and a second surface 108, defined by a layer of the second material 14; and applying the fourth material 109 to the second surface of the third material through an additive manufacturing process.

In one example, the applying step includes the step of contacting the additive manufacturing printer 122 with the second surface 108 of the third material 16. In one example: the moving step further comprises the step of activating an adhesive thereby adhering the first material 12 to the second material 14 to form the third material 16. In one aspect of the disclosure the activating step includes at least one of the steps of: applying light to the adhesive; applying heat to the adhesive; and applying pressure to the adhesive. In one example: the step of applying a force to the second material 14 at a location between the second mount 34 and the laminator 40; before the moving step, the step of separating a protective layer 88 of the first material 12 from the glass layer 82 of the first material 12; before the moving step, the step of separating the protective layer 98 of the second material 14 from the polycarbonate layer 92 of the second material 14; or any combination thereof.

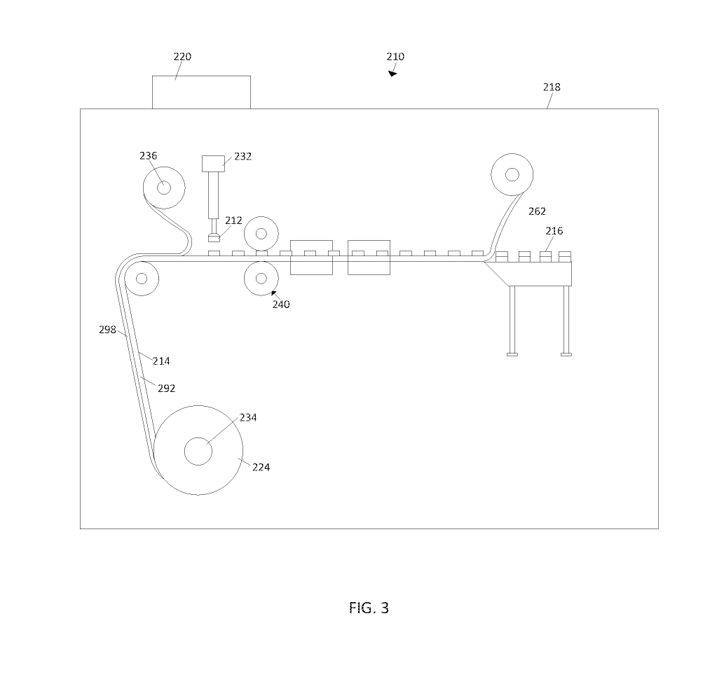

Referring to FIG. 3, a machine 210 can be configured to secure a first material 212 to a second material 214 thereby forming a third material 216. The machine 210 can include a frame 218 that at least partially encloses the first material 212, the second material 214, the third material 216, or any combination thereof during operation of the machine 210. In one example the frame 218 is configured to enclose an entirety of the first material 212, the second material 214, the third material 216, and all of the other components of the machine 210 during operation of the machine 210. The machine 210 can include a filtration system 220 configured to remove impurities, for example dust, from an area enclosed by the frame 218.

Referring to FIGS. 3 to 5, the machine 210 can be configured to receive a plurality of pieces of the first material 212. In one aspect of the disclosure, the machine 210 includes a mechanism, for example a movable arm 232 that is configured to place the plurality of pieces of the first material 212 relative to the second material 214. Each of the pieces of the first material 212 includes a respective outer perimeter 250 that defines a shape 252 of the respective piece of the first material 212. As shown in the illustrated example, the shape 252 of each of the plurality of pieces of the first material can be substantially identical (within manufacturing tolerances). In another example, some of the plurality of pieces of the first material can define a shape 252 that is different than the shape 252 of others of the plurality of pieces of the first material 212. The first material 212 is similar to the first material 12 as described herein such that the disclosure of the first material 12 herein also applies to the first material 212, except where identified below. One difference between the first material 212 and the first material 12 is that the first material 212 includes a plurality of separate pieces, while the first material 12 includes one continuous piece.

As shown in the illustrated example, the machine 210 can be configured to receive a roll 224 of the second material 214. The machine 10 can include a mount 234 rotatably coupled to the frame 218. The mount 234 can be configured to receive the roll 224. As shown in the illustrated example, the machine 210 can be configured such that the mount 234 is configured to receive the roll 224.

The second material 214 is similar to the second material 14 as described herein such that the disclosure of the second material 14 herein also applies to the second material 214, except where identified below. One difference between the second material 214 and the second material 14 is that the second material 214 can include a plurality of kiss-cuts 264, while the second material 14 can be devoid of such kiss-cuts.

In one aspect of the disclosure, the second material 214 includes a thermoplastic layer, for example a polycarbonate layer 292. The second material 214 can further include a protective layer 298 that is removably attached to the polycarbonate layer 292. The second material 214 can be configured such that the protective layer 298 is positioned between adjacent portions of the polycarbonate layer 292 when the second material 214 is mounted to the mount 234.

In one aspect of the disclosure, the machine 210 is configured to separate the protective layer 298 from the polycarbonate layer 292 and thus remove the protective layer 298 from the second material 214. As shown in the illustrated example, the machine 210 can include a mount 236 rotatably coupled to the frame 218 such that the mount 236 is configured to receive the removed protective layer 298 and form a roll of the protective layer 298 on the mount 236.

The machine 210 includes a laminator 240 configured to receive both the first material 212 and the second material 214 as separate inputs and output the third material 216, the third material 216 including at least a layer of the first material 212 secured to at least a layer of the second material 214. The laminator 240 is similar to the laminator 40 as described herein, such that the disclosure of the laminator 40 herein also applies to the laminator 240.

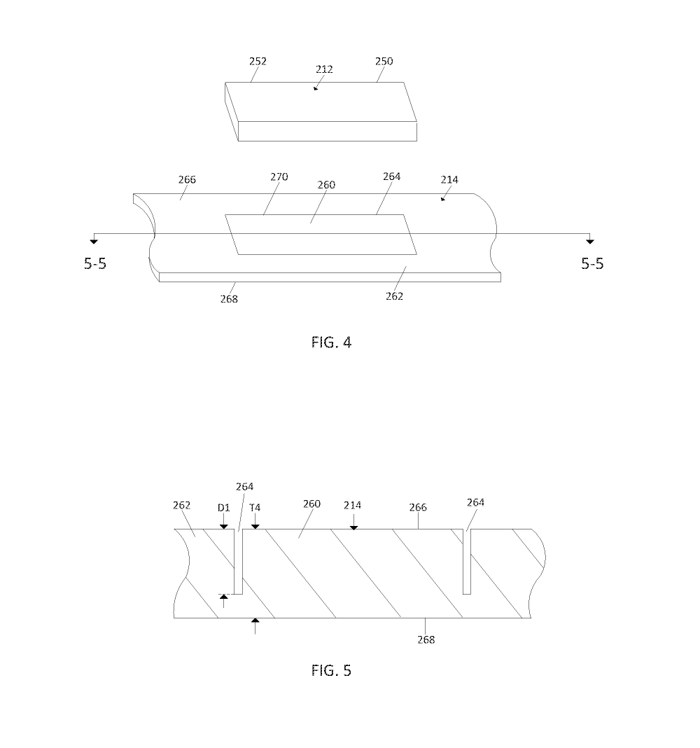

Referring to FIGS. 4 and 5, the second material 214 can include a plurality of first portions 260 (only one shown), a second portion 262, and a plurality of die cuts, for example kiss-cuts 264 (only one shown). Each of the plurality of kiss-cuts 264 as described herein includes a cut into a first surface 266 of the second material 214 toward a second surface 268 of the second material 214, such that the kiss-cut 264 does not extend through the second surface 268. The second material 214 can define a thickness T4 that is measured from the first surface 266 to the second surface 268 along a line that is substantially normal to both the first surface 266 and the second surface 268. The kiss-cut 264 defines a depth D1 measured along the same line such that the depth D1 is less than the thickness T4. As shown in the illustrated example, the kiss-cut 264 is positioned between the first portion 260 and the second portion 262 such that the kiss-cut 264 defines a shape 270 of the first portion 260. As shown in the illustrated example, the shape 252 can be substantially identical (within manufacturing tolerances) to the shape 270.

The plurality of die cuts can include kiss-cuts, perforation cuts, laser cuts, or any combination thereof. The second material 214 can be pre-cut, or cut in-line by the machine 10, or the machine 210 for example. The machine 10, the machine 210, or any others of the machine herein, can include a rotary die cutting assembly, a laser cutting assembly, a perforation cutting assembly, a kiss-cutting assembly, or any combination thereof.

Referring to FIGS. 3 to 5, the machine 210 can be configured to place the plurality of pieces of the first material 212 onto the second material 214 such that the outer perimeter 250 of each of the plurality of pieces 212 is aligned with a respective one of the kiss-cuts 264. The machine 210 can be further configured to move the aligned first material 212 and the second material 214 through the laminator 240 concurrently, thereby adhering each of the plurality of pieces of the first material 212 to a respective one of the plurality of first portions 260 of the second material 214, thereby forming the third material 216.

In one aspect of the disclosure, the machine 210 is configured to separate the second portion 262 from the first portion 260, thus removing the second portion 262 from the third material 216. As shown in the illustrated example, the machine 210 can include a mount 238 configured to receive the separated second portion 262 of the second material 214. The machine 210 can further be configured such that after removal of the second portion 262 from the third material 216, the third material 216, including a layer of the first material 212 adhered to a layer of the second material 214, the third material 216 is organized for additional processing or packaging.

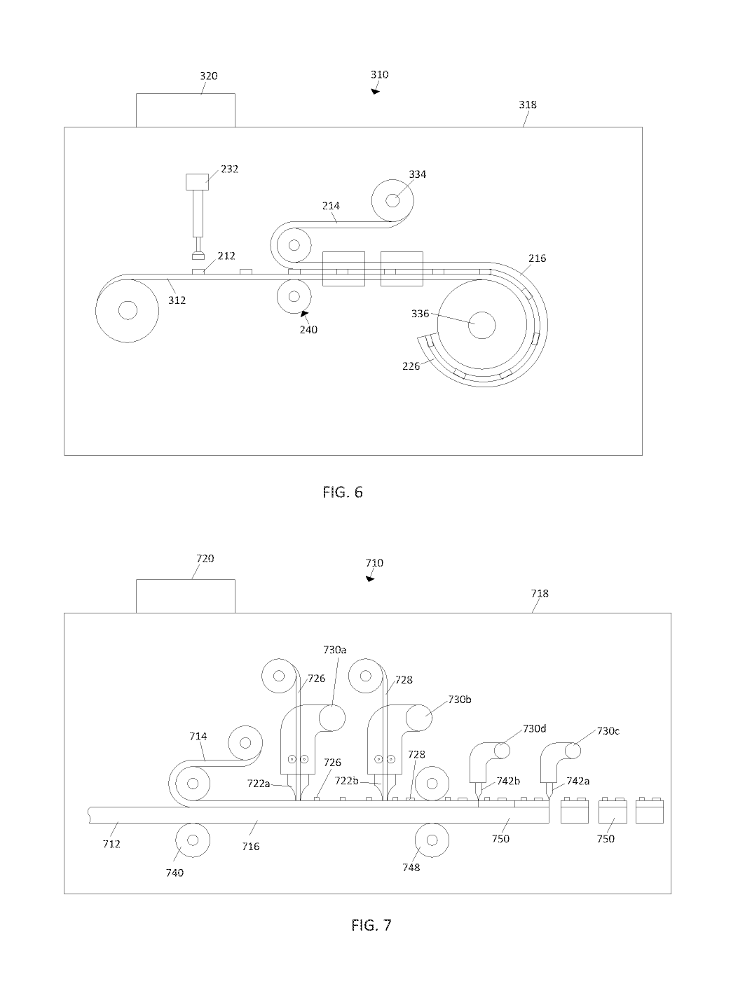

Referring to FIG. 6, a machine 310 can be configured to secure the first material 212 to a second material 214 thereby forming the third material 216. The machine 310 can include a frame 318 that at least partially encloses the first material 212, the second material 214, the third material 216, or any combination thereof during operation of the machine 310. In one example the frame 318 is configured to enclose an entirety of the first material 212, the second material 214, the third material 216, and all of the other components of the machine 310 during operation of the machine 310. The machine 310 can include a filtration system 320 configured to remove impurities, for example dust, from an area enclosed by the frame 318.

The machine 310 can include a conveyance material 312 configured to receive the plurality of pieces of the first material 212, for example from the movable arm 232, and move them toward the laminator 240. As shown in the illustrated example, the plurality of pieces of the first material 212 are configured to be placed on the conveyance material 312 and moved toward the laminator 240. The second material 214 is also moved toward the laminator 240, for example from a mount 334. As the first material 212 and the second material 214 pass through the laminator 240 the first material 212 is secured to the second material 214, for example as described in detail above with respect to FIG. 3. One difference between the machine 210 and the machine 310 is that in the machine 310 the third material 216 is formed on the conveyance material 312.

Referring to FIGS. 4 to 6, the machine 310 can include a mount 336 configured to receive the third material 216 and form a roll 226 of the third material 216. As shown in the illustrated example, the mount 336 is configured to form the roll 226 with the conveyance material 312 attached to the third material 216. In another aspect of the disclosure, the machine 310 can be configured to remove the conveyance material 312 from the third material 216 before forming the roll 226 of the third material 216. As shown in the illustrated example, the first portion 260 and the second portion 262 of the second material 214 can remain attached when the roll 226 of the third material 216 is formed. In another aspect of the disclosure, the machine 310 can be configured to separate the second portion 262 of the second material 214 from the first portion 260 of the second material 214, thus removing the second portion 262 from the third material 216 before the roll 226 is formed. The machine 310 can include a mount that is similar to the mount 238 as described in reference to FIG. 3, and that is also configured to separate the second portion 262 from the first portion 260.

Referring to FIG. 7, a machine 710 can be configured to secure a first material 712, for example a glass material, to a second material 714, for example a thermoplastic material such as a polycarbonate material, thereby forming a third material 716. The machine 710 can include a frame 718 that at least partially encloses the first material 712, the second material 714, the third material 716, or any combination thereof during operation of the machine 710. In one example the frame 718 is configured to enclose an entirety of the first material 712, the second material 714, the third material 716, and all of the other components of the machine 710 during operation of the machine 710. The machine 710 can include a filtration system 720 configured to remove impurities, for example dust, from an area enclosed by the frame 718.

The machine 710, according to one aspect of the disclosure, is configured to receive the first material 712 in the form of a roll, in the form of a sheet, in the form of a plurality of separate pieces, or any combination thereof. The machine 710 may further be configured to receive the second material 714 in the form of a roll, in the form of a sheet, in the form of a plurality of separate pieces, or any combination thereof. As shown in the illustrated embodiment, the machine 710 includes a laminator 740, for example a pair of nip rollers, the laminator 740 configured to adhere the first material 712 to the second material 714 to form the third material 716. As shown the third material 716 includes a first layer that includes the first material 712 and a second layer that includes the second material 714.

The machine 710, according to one embodiment, further includes at least one additive manufacturing printer 722 positioned so as to add additional material 724 to the third material 716, thereby forming a finished material 750. As shown in the illustrated embodiment, the machine 710 includes a first additive manufacturing printer 722a and a second additive manufacturing printer 722b, configured to add a fourth material 726 and a fifth material 728 to the third material 716, respectively. The fourth material 726 and the fifth material 728 can be the same material, for example an identical material. Alternatively, the fourth material 726 and the fifth material 728 can be different. For example, the fourth material 726 and the fifth material 728 can be different colored additive manufacturing material.

According to one aspect of the disclosure, the first additive manufacturing printer 722a can be mounted on a first robotic arm 730a and the second additive manufacturing printer 722b can be mounted on a second robotic arm 730b such that the machine 710 is configured to add additional material 724 to the third material 716 in a plurality of different configurations.

The machine 710 may include a tension mechanism 748 configured to maintain a desired amount of tension on the third material 716. The tension mechanism 748 may include a second pair of nip rollers. The tension mechanism 748 can provide a bond between the fourth material 726 and the third material 718. By applying a tension to the third surface 718, the base upon which the additive manufacturing material is added, thermal expansion of the third material 718 may be limited compared to a machine that lacks a tension mechanism 748. Limiting the thermal expansion of the third material 718 can result in minimized movement of the third material 718 during the additive manufacturing process, thus increasing the strength of the bond between the third material 718 and the fourth material 726.

The machine 710 may further include at least one cutting apparatus configured to separate the finished material 750 into a plurality of pieces. As shown in the illustrated embodiment, the machine 710 can include a first cutter 742a configured to cut though at least one of the first layer and the second layer a second cutter 742b configured to cut though at least the other of the first layer and the second layer, or both.

According to one aspect of the disclosure, the machine 710 include the first cutter 742a carried by a third robotic arm 730c, and the second cutter 742b is carried by a fourth robotic arm 730d. The first cutter 742a can include a YAG laser, or a CO₂ laser configured to cut the first layer, for example a glass layer, of the finished material 750, the second cutter 742b can include a YAG laser configured to cut the second layer, for example a polycarbonate layer, of the finished product 750, or both.

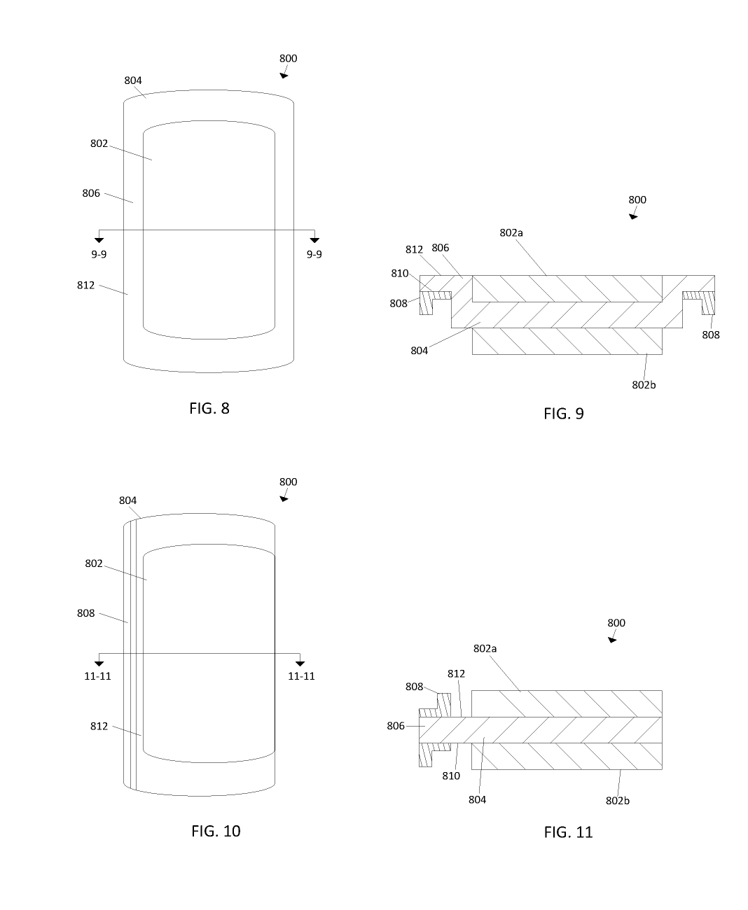

Referring to FIGS. 8 and 9, a material 800 includes a glass layer 802 and a polycarbonate layer 804. The glass layer 802 and the polycarbonate layer 804 can each define a different outer perimeter, for example such that the polycarbonate layer 804 is larger than the glass layer 802, as shown in the illustrated embodiment. As shown, the material 800 is configured such that a portion 806 of the polycarbonate layer 804 extends beyond the glass layer 802. The material 800 is configured such that the polycarbonate layer 804, including but not limited to the portion 806, is configured to receive material 808 from an additive manufacturing printer.

As shown in the illustrated embodiment, the material 800 can include a first glass layer 802a, a second glass layer 802b, and the polycarbonate layer 804 positioned between the first glass layer 802a and the second glass layer 802b. According to one aspect of the disclosure, the portion 806 is positioned peripherally with respect to the glass layer 802.

Referring to FIGS. 10 and 11, according to another aspect of the disclosure, the material 800 can be configured such that the portion 806 is positioned such that at least a portion of an outer perimeter of the glass layer 802 is aligned with at least a portion of an outer perimeter of the polymer layer 804.

Referring to FIGS. 8 to 11, the material 800 can be configured such that the material 808 is applied to a first side 810 of the portion 806, to a second side 812 of the portion 806 that is opposite the first side 810, or to both the first side 810 and the second side 812.

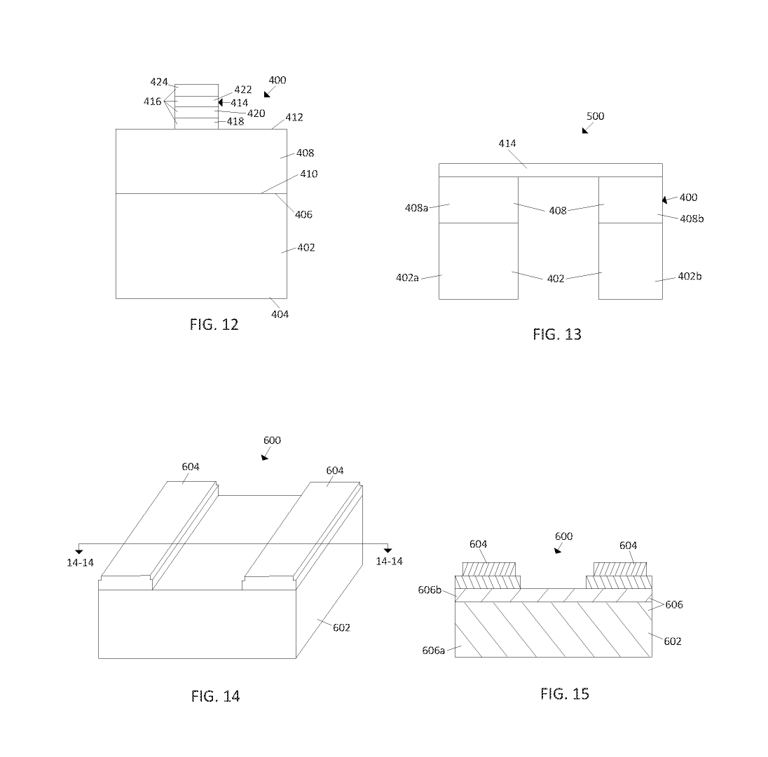

Referring to FIG. 12, a material 400 includes a glass layer 402 that includes a first surface 404 and a second surface 406. The first surface 404, as shown, can be opposite the second surface 406. The material 400 further includes a thermoplastic layer 408 that includes a first surface 410 and a second surface 412. The first surface 410, as shown, can be opposite the second surface 412. The glass layer 402 is secured to the thermoplastic layer 408 such that the second surface 406 of the glass layer 402 faces the first surface 410 of the thermoplastic layer 408. The material 400 further includes a third layer 414 that is secured to the second surface 412 of the thermoplastic layer 408 through an additive manufacturing process, for example three dimensional printing.

According to one aspect of the disclosure, the thermoplastic layer 408 can include a polycarbonate layer or sheet, for example a LEXAN™ sheet; a polyetherimide layer or sheet, for example an ULTEM™ sheet; a polycarbonate foam layer, for example LEXAN™ foam; a polyetherimide foam layer, for example ULTEM™ foam, or any combination thereof.

In one aspect of the disclosure, the third layer 414 includes a material that is configured to be extruded by an additive manufacturing printer. The third layer 414 can include a plurality of sub-layers 416. The plurality of sub-layers 416 can include a first layer 418 secured to the second surface 412 of the thermoplastic layer 408. The plurality of sub-layers 416 can further include a second layer 420 secured to the first layer 418. The plurality of sub-layers 416 can further include additional layers, for example a third sub-layer 422 and a fourth sub-layer 424, each secured to at least one of the plurality of sub-layers 416.

The glass layer 402 can be bendable, rollable, ultra-thin such that a thickness of the glass layer 402 is between about 50 microns and about 200 microns, or any combination thereof. The glass layer 402 can include, but is not limited to, chemically strengthened glass, soda lime glass, flexible glass, and tempered glass. The thermoplastic layer 408 can include, but is not limited to polycarbonates, polyetherimides, polyetheretherketones, or any combination thereof. The thermoplastic layer 408 can be in the form of a sheet, or a foam, or a combination thereof. The material 400 can include an adhesive configured to secure adjacent layers of the material 400 to each other. For example, the material 400 can include an adhesive between the glass layer 402 and the thermoplastic layer 408, between the thermoplastic layer 408 and the third layer 414, or both. The adhesive can be optically clear, pressure activated, light activated, heat activated, or any combination thereof. Alternatively, the material 400 can be devoid of an adhesive.

Additive manufacturing applied to a material that includes both a glass layer and a thermoplastic layer, such as the material 400, may result in a stronger bond than additive manufacturing material that is added to a material that includes only the glass layer, or only the thermoplastic layer. The glass layer 402 of the material 400 reduces the thermal coefficient of expansion of the material 400 compared to a material with only a thermoplastic layer. The reduced thermal coefficient of expansion reduces movement of the material 400 during the additive manufacturing process thereby enabling a stronger bond between the material 400 and the additive manufacturing material.

Referring to FIG. 13, an object 500 can include the material 400. The object 500 can include a plurality of separate first glass layers 402, a plurality of separate thermoplastic layers 408 each secured to a respective one of the plurality of first glass layers 402, and the third layer 414 secured to more than one of the plurality of separate thermoplastic layers 408. As shown in the illustrated example the object 500 can include a first glass layer 402a, a second glass layer 402b that is separate from the first glass layer 402a, a first thermoplastic layer 408a secured to the first glass layer 402a, a second thermoplastic layer 408b secured to the second glass layer 402b, and the third layer 414 secured to both the first thermoplastic layer 408a and the second thermoplastic layer 408b. In one aspect of the disclosure, the object 500 can be a standalone, finished product, such as a piece of furniture, for example a table. In another aspect of the disclosure, the object 500 can be a component of a larger structure, such as a touch screen of an electronic device.

Referring to FIGS. 12 and 13, a method of manufacturing the material 400 includes the steps of: securing one of the glass layer 402 and the thermoplastic layer 408 to the other of the glass layer 402 and the thermoplastic layer 408 such that the second surface 406 of the glass layer 402 faces the first surface 410 of the thermoplastic layer 408, and such that the second surface 412 of the thermoplastic layer 408 faces away from the glass layer 402; positioning an additive manufacturing printer, for example the additive manufacturing printer 122 (shown in FIG. 1), such that the additive manufacturing printer faces the second surface 412 of the thermoplastic layer 408; and extruding the third layer 414 from the additive manufacturing printer onto the second surface 412 of the thermoplastic layer 408, thereby securing the third layer 414 to the second surface 412 of the thermoplastic layer 408.

In one aspect of the disclosure, the method can further include the step of contacting the second surface 412 of the thermoplastic layer 408 with the additive manufacturing printer such that the additive manufacturing printer applies a force directly to the second surface 412 of the thermoplastic layer 408 during at least a portion of the extruding step. Note that the force referred to above, is in addition to any force applied to the second surface 412 of the thermoplastic layer 408 by the addition of the extruded material, or the third layer 414, to the second surface 412 of the thermoplastic layer 408. In one aspect of the disclosure, the method can further include the step of applying heat to at least a portion of the second surface 412 of the thermoplastic layer 408 during at least a portion of the extruding step.

Referring to FIGS. 14 and 15, a material 600 can include a first layer 602 and a second layer 604, the second layer 604 is configured to be extruded as part of an additive manufacturing process to secure the second layer 604 to the first layer 602. As shown in the illustrated example, the first layer 602 can include a plurality of sub-layers 606. The plurality of sub-layers 606 includes a first sub-layer 606a and a second sub-layer 606b. The second sub-layer 606b provides a smooth skin surface configured to maximize surface wetting with additive manufacturing molten material thus enabling improved bonding. The first layer 602 can include a foam material, polyetherimide foam, for example ULTEM™ foam; polycarbonate foam, for example LEXAN™ foam; polyethylene foam or any combination thereof.

In one aspect of the disclosure, the first layer 602 is secured directly to the second layer 604 such that the material 600 is devoid of an adhesive positioned between the first layer 602 and the second layer 604. In another aspect of the disclosure, the first layer 602 and the second layer 604 both include the same material or both include similar material. In one aspect of the disclosure, the first layer 602 and the second layer 604 both include a thermoplastic. In one aspect of the disclosure, the first layer 602 and the second layer 604 both include a polyetherimide, for example an ULTEM™ sheet or resin. In one aspect of the disclosure, the first layer 602 and the second layer 604 both include only polyetherimide, for example an ULTEM™ sheet or resin. In one aspect of the disclosure, the first layer 602 and the second layer 604 both include a polycarbonate, for example a LEXAN™ sheet or resin. In one aspect of the disclosure, the first layer 602 and the second layer 604 both include only a polycarbonate, for example a LEXAN™ sheet or resin.

A method of manufacturing the material 600 can include the steps of: positioning the first layer 602 such that a first side 608 of the first layer 602 faces an additive manufacturing printer; and applying the second layer 604 directly to the first side 608 of the first layer 602 through the additive manufacturing printer, such that the material 600 is devoid of an adhesive positioned between the first layer 602 and the second layer 604.

In an example the method of manufacturing the material 600 includes fused deposition modeling. The fused deposition modeling includes the steps of: positioning the first layer 602 relative to the additive manufacturing printer; just before depositing the second layer 604 onto the first layer 602, heating up the area of the first layer 602 that will come into immediate contact with the first layer 602, thereby raising the local temperature of the first layer 602 enough to result in a permanent bond between the first layer 602 and the second layer 604.

In another example, the method of manufacturing the material 600 includes selective laser sintering. The selective laser sintering includes the steps of: positioning the first layer 602 relative to the additive manufacturing printer; applying a laser to an area of the first layer 602 thereby softening the area; applying a powder to the first layer 602 such that the powder adheres to the softened area, thereby forming the second layer 604 secured to the first layer 602.

In one example, the first layer 602 and the second layer 604 can have similar colors, surface finishes, transparencies, or any combination thereof. In one example, the first layer 602 and the second layer 604 can have different colors, surface finishes, transparencies, or any combination thereof.

It will be appreciated that the foregoing description provides examples of the disclosed machines, methods, and materials. However, it is contemplated that other implementations of the disclosure can differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Although the disclosure has been described in detail, it should be understood that various changes, substitutions, and alterations can be made herein without departing from the spirit and scope of the present devices or techniques as defined by the appended claims. Moreover, the scope of the present disclosure is not intended to be limited to the particular examples described in the specification. As one of ordinary skill in the art will readily appreciate from the disclosure of the present devices, techniques, processes, machines, manufacture, composition of matter, means, methods, or steps, presently existing or later to be developed that perform substantially the same function or achieve substantially the same result as the corresponding examples described herein can be utilized in the present disclosure.

### LIST OF EXAMPLES

A non-exhaustive list of examples of examples of the machines described above is provided below, in addition to examples of the materials described above, as well as methods of manufacturing the materials described above.

Example 1—A machine comprising: a frame; a first mount rotatably coupled to the frame, the first mount configured to receive a roll of a first material; a first idler rotatably coupled to the frame, the first idler defining a first diameter of at least six inches; a second mount rotatably coupled to the frame, the second mount configured to receive a roll of a second material; a laminator coupled to the frame, the laminator configured to secure the first material and the second material relative to each other such that a third material is formed that includes both the first material and the second material; a second idler rotatably coupled to the frame, the second idler defining a second outer diameter at least fourteen inches; and a third mount rotatably coupled to the frame, the third mount configured to receive the third material such that a roll of the third material is formed on the third mount.

Example 2—The machine of example 1, wherein the machine defines an operating configuration in which: a roll of the first material is coupled to the first mount, the first material includes a first portion that exits the roll of the first material; a second portion of the first material contacts the first idler; a third portion of the first material enters the laminator; and the second portion is between the first portion and the third portion.

Example 3—The machine of example 2, wherein in the operating configuration: a roll of the second material is coupled to the second mount, the roll of the second material includes a first portion that exits the second mount; and a second portion of the second material enters the laminator.

Example 4—The machine of example 3, further comprising a third idler rotatably coupled to the frame such that in the operating configuration a third portion of the second material contacts the third idler, wherein the third portion of the second material is between the first portion of the second material and the second portion of the second material.

Example 5—The machine of example 4, wherein in the operating configuration the third idler applies a force to the third portion of the second material.

Example 6—The machine of example 5, further comprising a tension transducer configured to measure the force applied to the third portion of the second material.

Example 7—The machine of any one of examples 2 to 6, wherein in the operating configuration: a first portion of the third material exits the laminator; a second portion of the third material contacts the second idler; a third portion of the third material contacts the third mount; and the second portion of the third material is between the first portion of the third material and the third portion of the third material.

Example 8—The machine of any one of examples 2 to 10, wherein the first material includes a glass layer and the glass layer defines a thickness of between about 50 microns and about 200 microns.

Example 9—The machine of example 8, wherein when the machine is in the operating configuration: 1) the first material moves along a first path from the first mount to the laminator, and 2) the thickness is measured at a location and in a direction that is perpendicular to the first path 100 at the location.

Example 10—The machine of example 9, wherein the first material includes a protective layer.

Example 11—The machine of example 10, wherein the machine is configured to separate the protective layer from the glass layer and thus remove the protective layer from the first material, the machine further comprises a fourth mount rotatably coupled to the frame, and the fourth mount is configured to receive the removed protective layer such that a roll of the removed protective layer is formed on the fourth mount.

Example 12—The machine of example 11, wherein when the machine is in the operating configuration the protective layer is separated from the glass layer at a fourth portion of the first material, and the fourth portion of the first material is positioned between the second portion of the first material and the third portion of the first material.

Example 13—The machine of example 12, wherein the protective layer is a first protective layer, the second material includes a polycarbonate material and a second protective layer.

Example 14—The machine of example 13, wherein the machine is configured to separate the second protective layer from the polycarbonate material and thus remove the second protective layer from the second material, the machine further comprises a fifth mount rotatably coupled to the frame, and the fifth mount is configured to receive the removed second protective layer such that a roll of the removed second protective layer is formed on the fifth mount.

Example 15—The machine of any one of examples 3 to 6, wherein the second material includes a polycarbonate material.

Example 16—The machine of example 15, wherein the second material includes a protective layer.

Example 17—The machine of example 16, wherein the machine is configured to separate the protective layer from the polycarbonate material and thus remove the protective layer from the second material, the machine further comprises a fourth mount rotatably coupled to the frame, and the fourth mount is configured to receive the removed protective layer such that a roll of the removed protective layer is formed on the fourth mount.

Example 18—The machine of example 17, wherein when the machine is in the operating configuration the protective layer is separated from the polycarbonate material at a portion of the second material that is positioned between the first portion of the second material and the second portion of the second material.

Example 19—The machine of any one of example 1 to 18, wherein the laminator includes at least one of an ultraviolet light source, a heat source, and a pair of nip rollers.

Example 20—The machine of example 19, wherein the second material includes an adhesive that is at least one of light activated, heat activated, and pressure activated.

Example 21—The machine of any one of examples 1 to 20, further comprising an additive manufacturing printer configured to add a fourth material to the third material.

Example 22—The machine of example 21, further comprising a robotic arm that carries the additive manufacturing printer.

Example 23—The machine of any one of examples 1 to 22, wherein the first outer diameter is between six inches and sixteen inches, and the second outer diameter is between fourteen inches and twenty-four inches.

Example 24—The machine of example 23, wherein the first outer diameter is about sixteen inches, and the second outer diameter is about twenty-four inches.

Example 25—A method of manufacturing a composite material, the method comprising the steps of: unrolling a portion of a first material from a roll of the first material, the roll of the first material being coupled to a first mount of a machine; contacting the portion of the first material with at least a portion of a first idler of the machine, the first idler defining an outer diameter that is at least six inches; unrolling a portion of a second material from a roll of the second material, the roll of the second material being coupled to a second mount of the machine; moving the portion of the first material and the portion of the second material through a laminator concurrently thereby adhering the first material to the second material to form a third material; contacting a portion of the third material with at least a portion of a second idler of the machine, the second idler defining an outer diameter that is at least fourteen inches; and rolling the portion of the third material onto a roll of the third material, the roll of the third material being coupled to a third mount of the machine.

Example 26—The method of example 25, further comprising the step of applying a force to the second material at a location between the second mount and the laminator.

Example 27—The method of any one of examples 25 to 26, further comprising, before the moving step, the step of separating a protective layer of the first material from a glass layer of the first material.

Example 28—The method of any one of examples 25 to 27, further comprising, before the moving step, the step of separating a protective layer of the second material from a polycarbonate layer of the second material.

Example 29—The method of any one of examples 25 to 28, wherein the moving step further comprises the step of activating an adhesive thereby adhering the first material to the second material to form the third material.

Example 30—The method of example 29, wherein the activating step includes at least one of the steps of: applying light to the adhesive; applying heat to the adhesive; and applying pressure to the adhesive.

Example 31—A method of manufacturing a composite material, the method comprising the steps of: unrolling a portion of a first material from a roll of the first material, the roll of the first material being coupled to a first mount of a machine; contacting the portion of the first material with at least a portion of a first idler of the machine; unrolling a portion of a second material from a roll of the second material, the roll of the second material being coupled to a second mount of the machine; moving the portion of the first material and the portion of the second material through a laminator concurrently thereby adhering the first material to the second material to form a third material, the third material including a first surface defined by the first material, the third material including a second surface defined by the second material; and applying a fourth material to the second surface of the third material through an additive manufacturing process.

Example 32—The method of example 31, wherein the applying step includes the step of contacting an additive manufacturing printer with the second surface of the third material.

Example 33—The method of example 32, further comprising the step of applying a force to the second material at a location between the second mount and the laminator.

Example 34—The method of any one of examples 31 to 33, further comprising, before the moving step, the step of separating a protective layer of the first material from a glass layer of the first material.

Example 35—The method of any one of examples 31 to 34, further comprising, before the moving step, the step of separating a protective layer of the second material from a polycarbonate layer of the second material.

Example 36—The method of any one of examples 31 to 35, wherein the moving step further comprises the step of activating an adhesive thereby adhering the first material to the second material to form the third material.

Example 37—The method of example 36, wherein the activating step includes at least one of the steps of: applying light to the adhesive; applying heat to the adhesive; and applying pressure to the adhesive.

Example 38—A method of manufacturing a composite material, the method comprising the steps of: moving a piece of a first material toward a laminator of a machine, the piece including an outer perimeter that defines a first shape of the piece; unrolling a roll of a second material, the roll of the second material being coupled to a first mount of the machine, the second material including a first portion, a second portion, and a kiss-cut, the kiss-cut being positioned between the first portion and the second portion, and the kiss-cut defining a second shape of the first portion that substantially matches the first shape; moving the piece and the first portion through the laminator concurrently thereby adhering the piece to the first portion such that the outer perimeter is substantially aligned with the kiss-cut.

Example 39—The method of example 38, further comprising the step of separating the first portion from the second portion.

Example 40—The method of example 38, further comprising, after the second moving step, the step of rolling the piece and the portion onto a second mount of the machine.

Example 41—The method of example 40, further comprising the step of placing the piece onto a surface that is translatable relative to the laminator.

Example 42—The method of example 41, wherein the surface is defined by the second material.

Example 43—The method of example 41, wherein the surface is separate from the second material.

Example 44—The method of any one of examples 38 to 43, wherein the piece is a first piece, the outer perimeter is a first outer perimeter, and the kiss-cut is a first kiss-cut, the method further comprising the steps of: moving a second piece of a first material toward the laminator of a machine, the piece including a second outer perimeter that defines a third shape of the second piece; unrolling the roll of the second material, the second material including a third portion, a fourth portion, and a second kiss-cut, the second kiss-cut being positioned between the third portion and the fourth portion, and the second kiss-cut defining a fourth shape of the second portion that substantially matches the third shape; moving the second piece and the third portion through the laminator concurrently thereby adhering the second piece to the third portion such that the second outer perimeter is substantially aligned with the second kiss-cut.

Example 45—The method of example 44, wherein the first shape substantially matches the third shape.

Example 46—A material including: a glass layer that includes a first surface and a second surface, the first surface opposite the second surface; a polycarbonate layer that includes a first surface and a second surface, the first surface of the polycarbonate layer opposite the second surface of the polycarbonate layer, the polycarbonate layer secured to the glass layer such that the second surface of the glass layer faces the first surface of the polycarbonate layer; and a third layer that includes a plurality of sub-layers, a first of the plurality of sub-layers being secured to the second surface of the polycarbonate layer, a second of the plurality sub-layers secured to the first of the plurality of sub-layers, and a third of the plurality of sub-layers secured to the second of the plurality of sub-layers.

Example 47—The material of example 46, wherein the third layer is secured to the second surface of the polycarbonate layer through an additive manufacturing process.

Example 48—A method of manufacturing a material, the method comprising the steps of: securing a glass layer to a polycarbonate layer such that: 1) a first surface of the glass material faces a first surface of the polycarbonate material, and 2) a second surface of the polycarbonate faces away from the glass layer; positioning an additive manufacturing printer such that the additive manufacturing printer faces the second surface of the polycarbonate material; and extruding a third layer from the additive manufacturing printer onto the second surface of the polycarbonate layer, thereby securing the third layer to the second surface of the polycarbonate layer.

Example 49—The method of example 48 further comprising the step of contacting the second surface of the polycarbonate layer with the additive manufacturing printer such that the additive manufacturing printer applies a force to the second surface of the polycarbonate layer during at least a portion of the extruding step.

Example 50. The method of any one of examples 48 to 49, further comprising the step of applying heat to at least a portion of the second surface of the polycarbonate layer during at least a portion of the extruding step.

Example 51. A composite material including: a first layer that includes a first thermoplastic material; and a second layer that includes a second thermoplastic material, the second layer further including a plurality of sub-layers, a first of the plurality of sub-layers being secured to the second surface of the first layer, a second of the plurality sub-layers being secured to the first of the plurality of sub-layers, and a third of the plurality of sub-layers being secured to the second of the plurality of sub-layers; wherein the first of the plurality of sub-layers is secured directly to the first layer such that the composite material is devoid of an adhesive positioned between the first layer and the second layer.

Example 52—The composite material of example 51, wherein both the first thermoplastic material and the second thermoplastic material include a polycarbonate.

Example 53—The composite material of example 52, wherein the polycarbonate includes LEXAN™ resin, LEXAN™ sheet, LEXAN™ foam, or any combination thereof.

Example 54—The composite material of example 53, wherein both the first thermoplastic material and the second thermoplastic material are devoid of any material that is not LEXAN™ resin, LEXAN™ sheet, LEXAN™ foam, or any combination thereof.

Example 55—The composite material of claim 51, wherein the first thermoplastic material includes a first polyetherimide and the second thermoplastic material includes a second polyetherimide.

Example 56—The composite material of example 55, wherein the first polyetherimide is chemically identical to the second polyetherimide.

Example 57—The composite material of example 56, wherein the first thermoplastic material consists of the first polyetherimide, and the second thermoplastic materials consists of the second polyetherimide.

Example 58—The composite material of claim 55, wherein the at least one of the first thermoplastic material and the second thermoplastic material includes ULTEM™ resin, ULTEM™ sheet, ULTEM™ foam, or any combination thereof.

Example 59—A method of manufacturing a composite material, the method comprising the steps of: positioning a first thermoplastic material such that a first side of the first thermoplastic material faces an additive manufacturing printer; applying a layer of a second thermoplastic material directly to the first side of the first thermoplastic material through the additive manufacturing printer, such that the composite material is devoid of an adhesive positioned between the first thermoplastic material and the second thermoplastic material.

Example 60—The method of example 59, wherein the first thermoplastic material includes LEXAN™ resin, LEXAN™ sheet, LEXAN™ foam, or any combination thereof, and the second thermoplastic material includes LEXAN™ resin, LEXAN™ sheet, LEXAN™ foam, or any combination thereof.

Example 61—The method of example 60, wherein at least one of the first thermoplastic material and the second thermoplastic material consists of LEXAN™ resin, LEXAN™ sheet, LEXAN™ foam, or any combination thereof.

Example 62—The method of example 61, wherein both the first thermoplastic material and the second thermoplastic material consist of LEXAN™ resin, LEXAN™ sheet, LEXAN™ foam, or any combination thereof.

Example 63—The method of example 62, wherein the first thermoplastic material includes ULTEM™ resin, ULTEM™ sheet, ULTEM™ foam, or any combination thereof, and the second thermoplastic material includes ULTEM™ resin, ULTEM™ sheet, ULTEM™ foam, or any combination thereof.

Example 64—The method of example 63, wherein at least one of the first thermoplastic material and the second thermoplastic material consists of ULTEM™ resin, ULTEM™ sheet, ULTEM™ foam, or any combination thereof.

Example 65—The method of example 64, wherein both the first thermoplastic material and the second thermoplastic material consist of ULTEM™ resin, ULTEM™ sheet, ULTEM™ foam, or any combination thereof.

Example 66—The method of example 59, wherein the first thermoplastic material is a glass material, and the second thermoplastic material is includes ULTEM™ 1040 or ULTEM™ CRS.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

We claim:

1. A machine comprising:
a frame;
a first mount rotatably coupled to the frame, the first mount configured to receive a roll of a first material;
a first idler rotatably coupled to the frame, the first idler defining a first diameter of at least six inches;
a second mount rotatably coupled to the frame, the second mount configured to receive a roll of a second material;
a laminator coupled to the frame, the laminator configured to secure the first material and the second material relative to each other such that a third material is formed that includes both the first material and the second material;
a second idler rotatably coupled to the frame, the second idler defining a second diameter at least fourteen inches; and
a third mount rotatably coupled to the frame, the third mount configured to receive the third material such that a roll of the third material is formed on the third mount.

2. The machine of claim 1, wherein the machine defines an operating configuration in which:
a roll of the first material is coupled to the first mount, the roll of the first material includes a first portion of the first material;
a second portion of the first material contacts the first idler;
a third portion of the first material enters the laminator; and
the second portion is between the first portion and the third portion.

3. The machine of claim 1, wherein the first diameter is between six inches and sixteen inches, and the second diameter is between fourteen inches and twenty-four inches.

4. The machine of claim 2, wherein in the operating configuration: a roll of the second material is coupled to the second mount, the roll of the second material includes a first portion that exits the second mount; and a second portion of the second material enters the laminator.

5. The machine of claim 2, further comprising a third idler rotatably coupled to the frame such that in the operating configuration a third portion of the second material contacts the third idler, wherein the third portion of the second material is between the first portion of the second material and the second portion of the second material.

6. The machine of claim 2, wherein in the operating configuration the third idler applies a force to the third portion of the second material.

7. The machine of claim 2, further comprising a tension transducer configured to measure the force applied to the third portion of the second material.

8. The machine of claim 2, wherein in the operating configuration: a first portion of the third material exits the laminator; a second portion of the third material contacts the second idler; a third portion of the third material contacts the third mount; and the second portion of the third material is between the first portion of the third material and the third portion of the third material.

9. A method of manufacturing a composite material, the method comprising the steps of:
unrolling a portion of a first material from a roll of the first material, the roll of the first material being coupled to a first mount of a machine;
contacting the portion of the first material with at least a portion of a first idler of the machine, the first idler defining an outer diameter that is at least six inches;
unrolling a portion of a second material from a roll of the second material, the roll of the second material being coupled to a second mount of the machine;
moving the portion of the first material and the portion of the second material through a laminator concurrently thereby adhering the first material to the second material to form a third material;
contacting a portion of the third material with at least a portion of a second idler of the machine, the second idler defining an outer diameter that is at least fourteen inches; and
rolling the portion of the third material onto a roll of the third material, the roll of the third material being coupled to a third mount of the machine.

10. The method of claim 9, further comprising the step of applying a force to the second material at a location between the second mount and the laminator.

11. The method of claim 9, further comprising, before the moving step, the step of separating a protective layer of the first material from a glass layer of the first material.

12. The method of claim 9, further comprising, before the moving step, the step of separating a protective layer of the second material from a polycarbonate layer of the second material.

13. The method of claim 9, wherein the moving step further comprises the step of activating an adhesive thereby adhering the first material to the second material to form the third material.

14-16. (canceled)
